(19) United States
(12) Patent Application Publication
(10) Pub. No.: US 2025/0147171 A1
(43) Pub. Date: May 8, 2025

(54) MOTION DETECTION METHOD AND ELECTRONIC DEVICE APPLYING THE SAME

(71) Applicant: MEDIATEK INC., Hsinchu City (TW)

(72) Inventors: Tsung-Han Tsai, Hsinchu City (TW); Hsuan-Yu Liu, Hsinchu City (TW); Jun-Shen Chen, Hsinchu City (TW); Ting-Hsiang Wang, Hsinchu City (TW); I-Ying Liu, Hsinchu City (TW)

(21) Appl. No.: 18/941,225

(22) Filed: Nov. 8, 2024

Related U.S. Application Data
(60) Provisional application No. 63/597,008, filed on Nov. 8, 2023.

(51) Int. Cl. G01S 13/62; G01S 13/04

(52) U.S. Cl. CPC G01S 13/62; G01S 13/04

(57) ABSTRACT

The application discloses a motion detection method and an electronic device applying the same. A plurality of transmission packets are transmitted and a plurality of received packets are received. A received packet among the plurality of received packets is compensated into a compensated received packet. Cross packet cancellation is performed on the compensated received packet. A packet difference between the compensated received packet and another received packet among the plurality of received packets is determined. Whether an object is detected based on the packet difference is determined.

This application claims the benefit of U.S. provisional patent application Ser. No. 63/597,008, filed Nov. 8, 2023, the disclosure of which is incorporated by reference herein in its entirety.

### TECHNICAL FIELD

The disclosure relates to a motion detection method and an electronic device applying the same.

### BACKGROUND

Radars are used in a variety of systems for object detection, localization, classification, and/or velocity estimation. For example, a vehicle can be equipped with a radar to detect and monitor nearby vehicles and other obstacles. A frequency modulated continuous wave (FMCW) radar is type of radar that scans a field-of-view (FOV) by transmitting one or more chirps. A chirp is a radio frequency (RF) signal that is modulated, for example, by sweeping through a range of frequencies over a chirp duration. The transmitted chirp (or a portion thereof) may then be scattered by an object and reflected back to the FMCW radar. In general, the reflected chirp is a time-delayed version of the transmitted chirp. Thus, the reflected chirp can be processed to estimate a range (i.e., distance) between the FMCW radar and the object, for example, by using a digital signal processing technique such as a range fast Fourier transform (FFT). The FMCW radar can also be used to estimate a velocity of the object by transmitting a sequence of chirps. If the object is moving, then a sequence of reflected chirps will be received by the FMCW radar after different time delays from respective transmitted chirps, and thus the velocity of the object can be estimated, for example, by using a digital signal processing technique such as a Doppler FFT.

Motion detection is used to automatically identify and respond to movement within a specified area. The primary purposes of motion detection include: (1) Security and Surveillance: Motion detection is widely used in security cameras and alarm systems to identify unauthorized entry, suspicious activity, or unusual movement. It can trigger alerts or record video only when movement is detected, saving storage and reducing the need for constant monitoring. (2) Home Automation: In smart homes, motion detectors can automate functions like turning lights on/off when someone enters or leaves a room, adjusting thermostats, or activating smart appliances, helping to save energy and improve convenience. (3) Traffic and Pedestrian Monitoring: Motion detection in traffic cameras and sensors can monitor road and foot traffic, count vehicles or people, and trigger traffic lights or alerts to improve traffic flow and safety at intersections. (4) Healthcare and Elder Care: In hospitals or assisted living facilities, motion detectors can monitor patients' movement to detect falls, wandering, or irregular activity, helping caregivers respond quickly when assistance is needed. (5) Wildlife Observation and Research: Motion sensors in wildlife research help capture animal movements, track their behavior, or study habits in their natural habitat without human interference. (6) Sports and Fitness Tracking: Motion detection technology in wearables and fitness apps can track activity levels, form, and movement patterns. It helps users and trainers optimize workouts, monitor performance, and even guide exercise form.

Overall, motion detection automates responses to movement, enhancing safety, efficiency, and data collection across a wide range of applications.

Thus, there is a need to efficiently and correctly detect motion especially when the detection object is human.

### SUMMARY

According to one embodiment, a motion detection method is provided. The motion detection method includes: transmitting a plurality of transmission packets; receiving a plurality of received packets; compensating a received packet among the plurality of received packets into a compensated received packet; performing cross packet cancellation on the compensated received packet; determining a packet difference between the compensated received packet and another received packet among the plurality of received packets; and determining whether an object is detected based on the packet difference.

According to another embodiment, an electronic device for motion detection is provided. The electronic device for motion detection includes: a controller and a radar transceiver coupled to the controller. The controller is configured for: controlling the radar transceiver for transmitting a plurality of transmission packets; receiving a plurality of received packets from the radar transceiver; compensating a received packet among the plurality of received packets into a compensated received packet; performing cross packet cancellation on the compensated received packet; determining a packet difference between the compensated received packet and another received packet among the plurality of received packets; and determining whether an object is detected based on the packet difference.

### BRIEF DESCRIPTION OF THE DRAWINGS

FIG. 1 shows a functional block diagram of an electronic device for motion detection according to one embodiment of the application.

FIG. 2 shows a flow chart for cross packet motion detection according to one embodiment of the application.

FIG. 3 shows a flow chart for motion detection by environments calibration according to one embodiment of the application.

FIG. 4A and FIG. 4B show two cases in one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

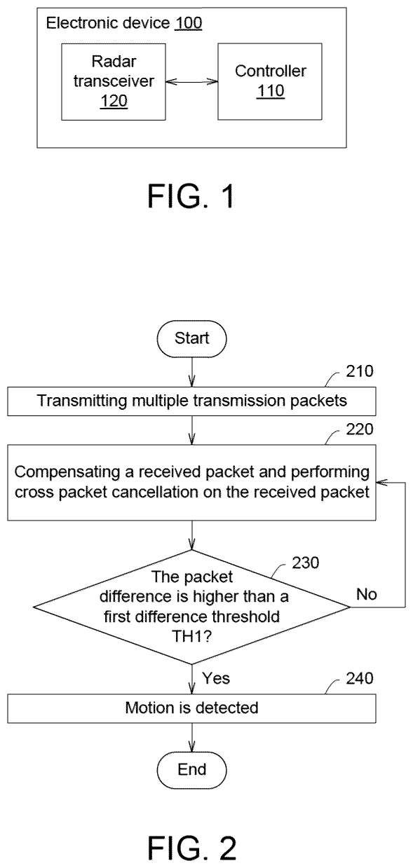

FIG. 1 shows a functional block diagram of an electronic device for motion detection according to one embodiment of the application. The electronic device 100 for motion detection according to one embodiment of the application includes a controller 110 and a radar transceiver 120.

The controller 110 is coupled to the radar transceiver 120. The controller 110 controls the radar transceiver 120 to transmit multiple packets for cross packets motion detection. Also, the controller 110 controls the radar transceiver 120 to transmit multiple sensing packets for motion detection by environments calibration.

The radar transceiver 120 transmits packets and receives packets.

In one embodiment of the application, when there is a need to do motion detection, the controller 110 uses cross packet cancellation to distinguish the difference between different packets. In one possible example, the difference D between different any two packets pkt_n and pkt_n+m is defined as: D=pkt_n-pkt_n+m, wherein n and m are both positive integers. That is, the packet difference D is generated by subtracting the packet pkt_n+m from the packet pkt_n. However, the application is not limited by this. Other possible methods to define the difference between different packets are still within the spirit and scope of the application.

The packet pkt_n and the packet pkt_n+m have difference in magnitude and/or phase and/or timing. Thus, the frequency offset and/or the timing offset and/or the magnitude offset and/or the phase offset of the packet pkt_n is/are compensated before cross packet cancellation.

One embodiment of the application also discloses environments calibration for motion detection.

Details about cross packet motion detection are described.

FIG. 2 shows a flow chart for cross packet motion detection according to one embodiment of the application.

In step 210, the controller 110 controls the radar transceiver 120 to transmit multiple transmission packets for cross packets motion detection.

In step 220, the controller compensates a received packet among a plurality of received packets and performs cross packet cancellation on the received packet. Step 220 is repeated to compensate the plurality of received packets one by one and perform cross packet cancellation on the plurality of received packets one by one. A plurality of reflected packets are reflected from the detection object when the transmission packets hit the detection object. The reflected packets are received by the radar transceiver 120 as the received packets and the radar transceiver sends the received packets to the controller 110. In one possible example, cross packet cancellation is described as below, which is not to limit the application. In one embodiment, the operations of compensating and performing cross packet cancellation are iteratively applied to each of the received packets in a one-by-one process.

It is assumed that the first received packet pkt_n and the second received packet pkt_n+1 (n being a positive integer) are FMCW de-chirp outputs in this case. In the following, the first received packet pkt_n is selected by the controller 110 as the target received packet, but the application is not limited by this.

In the following, one possible example is described, which is not to limit the application.

The first received packet pkt_n is expressed as: pkt_n=A*e^{j(2πf}^{₁}^{t+θ)}+∈, while the second received packet pkt_n+1 is expressed as: pkt_n+1=B*e^{j(2πf}^{₂}^{t+φ)} (using maximum sinusoid as reference here, wherein “∈” is the motion part). In here, f₁ and f₂ are respective frequencies of the first received packet pkt_n and the second received packet pkt_n+1. “A” and “B” are respective magnitudes of the first received packet pkt_n and the second received packet pkt_n+1. The parameters “θ” and “100 ” are respective phases of the first received packet pkt_n and the second received packet pkt_n+1.

Before cross packet cancellation, compensation is performed to align (or compensate) timing and/or magnitude and/or phase between the first received packet pkt_n and the second received packet pkt_n+1.

(1) Timing alignment is to align the frequencies f₁ and f₂, wherein timing difference will be frequency difference in FMCW de-chirp out.

After timing alignment, the first received packet pkt_n becomes:

$$pkt\_n = ( {Ae}^{j ( 2 π {f}_{1} t + θ )} + ϵ ) \times {e}^{j ( 2 π ( {f}_{2} - {f}_{1} ) t )} = {Ae}^{j ( 2 {f}_{2} t + θ )} + ϵ \times {e}^{j ( 2 π ( {f}_{2} - {f}_{1} ) t ) .}$$

(2) Magnitude alignment is to align the magnitudes “A” and “B”. After magnitude alignment, the first received packet pkt_n becomes:

$$pkt\_n = {Ae}^{j ( 2 π {f}_{2} t + θ )} \times B / A = {Be}^{j ( 2 π {f}_{1} t + θ )} + ϵ B / A \times {e}^{j ( 2 π ( {f}_{2} - {f}_{1} ) t )}$$

(3) Phase alignment is to align the phase “θ” and “φ”. After phase alignment, the first received packet pkt_n becomes:

$$D = pkt\_n - pkt\_n + 1 = ( ϵ B / A ) {e}^{j ( 2 π ( {f}_{2} - {f}_{1} ) t + φ - θ )} .$$

Cross packet cancellation as below is performed to find the packet difference D between the first received packet pkt_n and the second received packet pkt_n+1.

$$pkt\_n = {Ae}^{j ( 2 π {f}_{2} t + θ )} \times {e}^{j ( φ - θ )} = {Be}^{j ( 2 π {f}_{2} t + φ )} + ( ϵ B / A ) {e}^{j ( 2 π ( {f}_{2} - {f}_{1} ) t + φ - θ )} .$$

Thus, after cross packet cancellation, the motion part “∈” is extracted.

Although the successive received packets pkt_n and pkt_n+1 are taken as an example, the application is not limited by this. One skilled person in the art would understand how to do cross packet cancellation on non-successive received packets pkt_n and pkt_n+m (m being a positive integer larger than 1).

In step 230, the controller determines whether the packet difference D between the first received packet pkt_n and the second received packet pkt_n+1 is higher than a first difference threshold TH1 or not. When the packet difference D between the first received packet pkt_n and the second received packet pkt_n+1 is higher than the first difference threshold TH1, the controller determines that the motion is detected (for example but not limited by, a person is detected) in step 240.

When the packet difference D between the first received packet pkt_n and the second received packet pkt_n+1 is not higher than the first difference threshold TH1, the controller determines that there is no motion detection (for example but not limited by, there is no human body with the detection range of the radar transceiver) and the flow returns to step 220.

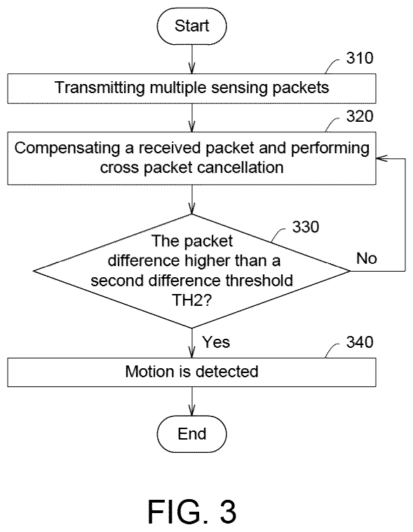

Details about motion detection by environments calibration are described. FIG. 3 shows a flow chart for motion detection by environments calibration according to one embodiment of the application.

In step 310, the controller 110 controls the radar transceiver 120 to transmit multiple sensing packets for motion detection by environments calibration. In here, the sensing packets may have, for example but not limited by, zero magnitude and thus, the sensing packets also referred as empty packets. The sensing packets are reflected from an object and received by the radar transceiver 120.

In step 320, the controller compensates a received packet and performs cross packet cancellation in motion detection by environments calibration on the received packet to find a packet difference D between the received packet and the sensing packet. Step 320 is repeated to compensate the plurality of received packets one by one and perform cross packet cancellation on the plurality of received packets one by one. The received packets are received from the detection object when the sensing packets hit the detection object. In step 320, compensation and the cross packet cancellation may be the same or similar to those in the step 220, and thus the details of the step 320 are not repeated here.

In step 330, the controller determines whether the packet difference D between the received packet and the sensing packet is higher than a second difference threshold TH2 or not (the second difference threshold TH2 may be the same or different from the first difference threshold TH1). When the packet difference D between the received packet and the sensing packet is higher than the second difference threshold TH2, the controller determines that the motion is detected (for example but not limited by, a person is detected) in step 340.

When the packet difference D between the received packet and the sensing packet is not higher than the second difference threshold TH2, the controller determines that there is no motion detection (for example but not limited by, there is no human body with the detection range of the radar transceiver) and the flow returns to step 320.

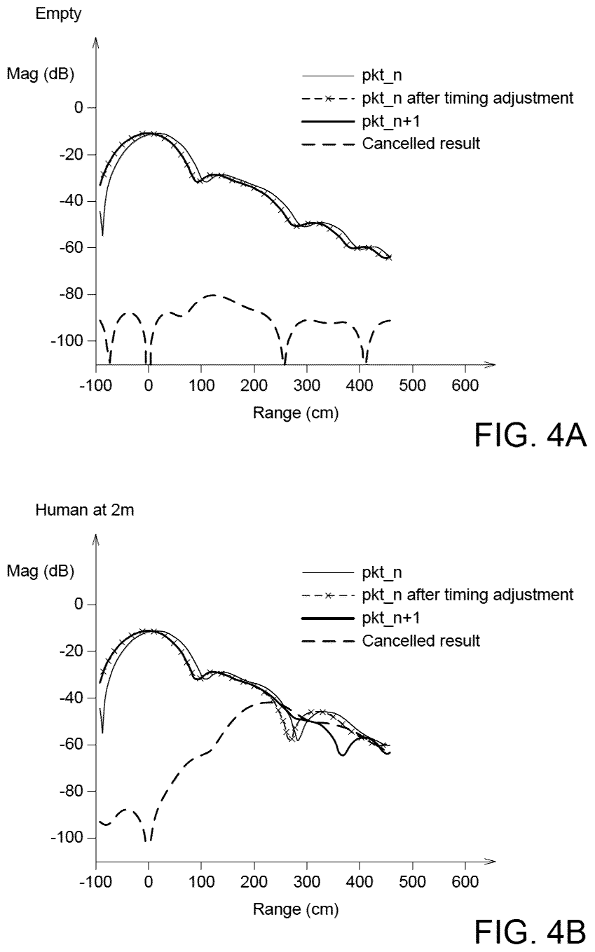

FIG. 4A and FIG. 4B show two cases in one embodiment of the application. FIG. 4A shows the case that the environment is empty (i.e. there is no any object in the sensing range). FIG. 4B shows the case that a human body is at two meters away from the motion detection electronic device (100).

FIG. 4A and FIG. 4B also show four curves, one curve for the received packet pkt_n, one curve for the received packet pkt_n after timing adjustment (i.e. after timing alignment or after timing compensation), one for the received packet pkt_n+1 and one for the cancelled result (i.e. the packet difference D).

As shown in FIG. 4A and FIG. 4B, after cross packet cancellation, one embodiment of the application can correctly detect motion.

Further, in empty test (i.e. there is no any object in the sensing range), the prior art motion detection has several motion detected. On the contrary, in one embodiment of the application, after cross packet cancellation, the packet difference D is very low, which indicates the environment is empty.

In one embodiment of the application, after packet compensation (phase, magnitude, timing and etc.) and cross packet cancellation, motion detection can correctly detect object in the sensing range.

The above primarily describes the solutions provided in the embodiments of the present application from the perspective of motion detection. It is understood that to achieve the above functions, the motion detection electronic device includes corresponding hardware structures and/or software modules that execute functions. Professionals in the technical field can easily recognize that the units and algorithm steps described in the embodiments of the present application can be implemented in hardware form or a combination of hardware and computer software. Whether the functions are performed by hardware or by hardware driven by computer software depends on the specific application and design constraints of the technical solution. Professionals in the technical field can use different methods to implement the functions described in each specific application without departing from the scope of the present application.

In one embodiment of the present application, the motion detection electronic device can be divided into functional modules based on the aforementioned method examples. For instance, each functional module can be obtained by dividing according to each corresponding function, or two or more functions can be integrated into one processing module. The integrated module can be implemented in hardware form or as a software functional module. It should be noted that in the embodiments of the present application, the division into modules is merely an example and is a logical function division. In the actual implementation process, other division methods can be used.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of a sub-combination. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A motion detection method comprising:
transmitting a plurality of transmission packets;
receiving a plurality of received packets;
compensating a received packet among the plurality of received packets into a compensated received packet;
performing cross packet cancellation on the compensated received packet;
determining a packet difference between the compensated received packet and another received packet among the plurality of received packets; and
determining whether an object is detected based on the packet difference.

2. The motion detection method according to claim 1, wherein compensating the received packet includes:
compensating a timing offset of the received packet based on the another received packet.

3. The motion detection method according to claim 1, wherein compensating the received packet includes:
compensating a magnitude offset of the received packet based on the another received packet.

4. The motion detection method according to claim 1, wherein compensating the received packet includes:
compensating a phase offset of the received packet based on the another received packet.

5. The motion detection method according to claim 1, wherein performing cross packet cancellation includes:
subtracting the another received packet from the received packet to determine the packet difference.

6. The motion detection method according to claim 1, wherein
in response that the packet difference is higher than a first difference threshold, it is determined that the object is detected; and
in response that the packet difference is not higher than the first difference threshold, it is determined that the object is not detected.

7. The motion detection method according to claim 1, wherein in motion detection by environments calibration, the plurality of transmission packets are empty packets.

8. The motion detection method according to claim 1, wherein the steps of compensating and performing cross packet cancellation are iteratively applied to each of the plurality of received packets in a one-by-one process.

9. An electronic device for motion detection including:
a controller, and
a radar transceiver coupled to the controller,
wherein the controller is configured for:
controlling the radar transceiver for transmitting a plurality of transmission packets;
receiving a plurality of received packets from the radar transceiver;
compensating a received packet among the plurality of received packets into a compensated received packet;
performing cross packet cancellation on the compensated received packet;
determining a packet difference between the compensated received packet and another received packet among the plurality of received packets; and
determining whether an object is detected based on the packet difference.

10. The electronic device according to claim 9, wherein in compensating the received packet, the controller is configured for:
compensating a timing offset of the received packet based on the another received packet.

11. The electronic device method according to claim 9, wherein in compensating the received packet, the controller is configured for:
compensating a magnitude offset of the received packet based on the another received packet.

12. The electronic device according to claim 9, wherein in compensating the received packet, the controller is configured for:
compensating a phase offset of the received packet based on the another received packet.

13. The electronic device according to claim 9, wherein in performing cross packet cancellation, the controller is configured for:
subtracting the another received packet from the received packet to determine the packet difference.

14. The electronic device according to claim 9, wherein the controller is configured for:
in response that the packet difference is higher than a first difference threshold, determining that the object is detected; and
in response that the packet difference is not higher than the first difference threshold, determining that the object is not detected.

15. The electronic device according to claim 9, wherein in motion detection by environments calibration, the plurality of transmission packets are empty packets.

16. The electronic device according to claim 9, wherein the operations of compensating and performing cross packet cancellation are iteratively applied to each of the plurality of received packets in a one-by-one process.
